(19) United States
(12) Patent Application Publication
(10) Pub. No.: US 2025/0203496 A1
(43) Pub. Date: Jun. 19, 2025

(54) COMMUNICATION APPARATUS, METHOD OF COMMUNICATION APPARATUS, TERMINAL APPARATUS, METHOD OF TERMINAL APPARATUS, COMMUNICATION SYSTEM, AND NON-TRANSITORY COMPUTER-READABLE MEDIUM

(71) Applicant: NEC Corporation, Minato-ku, Tokyo (JP)

(72) Inventor: Kana AONO, Tokyo (JP)

(73) Assignee: NEC Corporation, Minato-ku, Tokyo (JP)

(21) Appl. No.: 18/842,869

(22) PCT Filed: Mar. 14, 2022
(86) PCT No.: PCT/JP2022/011288

§ 371 Date: Aug. 30, 2024

(51) Int. Cl. H04W 48/16; H04W 60/04; H04W 76/50; H04W 84/04

(52) U.S. Cl. CPC H04W 48/16; H04W 60/04; H04W 76/50; H04W 84/042

(57) ABSTRACT

An object is to provide a communication apparatus capable of preventing a rapid increase in traffic in a mobile communication network capable of providing a communication service when a disaster occurs. A communication apparatus (1) according to the present disclosure includes: a transmission unit (2) configured to transmit list information indicating networks that are available when a disaster occurs in a case where identification information of a terminal apparatus is associated with a high-priority terminal, and configured not to transmit the list information in a case where the identification information is not associated with the high-priority terminal.

### TECHNICAL FIELD

The present disclosure relates to a communication apparatus, a method of a communication apparatus, a terminal apparatus, a method of a terminal apparatus, a communication system, and a non-transitory computer-readable medium.

### BACKGROUND ART

In a case where a failure occurs in a mobile communication network managed by a certain communication carrier at the time of disaster, an access form that enables a communication terminal to access a mobile communication network managed by another communication carrier instead of the failed mobile communication network has been studied.

Non Patent Literature 1 discloses that a mobile communication network distributes public land mobile network (PLMN) list information including a PLMN available at the time of disaster to a communication terminal. When a disaster occurs, the communication terminal can access the PLMN included in the PLMN list (a mobile communication network managed by another communication carrier) instead of the failed mobile communication network, and can receive a communication service.

Non Patent Literature 2 discloses a flow of Registration processing of a user equipment (UE). The UE receives a Registration Accept message indicating completion of the Registration processing in a mobile communication network. The Registration Accept message includes PLMN list information including a PLMN available at the time of disaster.

### CITATION LIST

### Non Patent Literature

Non Patent Literature 1: 3GPP TS 23.501 V17.3.0 (2021-12)
Non Patent Literature 2: 3GPP TS 23.502 V17.3.0 (2021-12)

### SUMMARY OF INVENTION

### Technical Problem

However, when communication systems disclosed in Non Patent Literatures 1 and 2 are used, a large number of communication terminals using a failed PLMN when a disaster occurs attempt to access another PLMN at the same time. At this time, there is a problem that traffic in the another PLMN rapidly increases and congestion occurs.

In view of the above-described problems, an object of the present disclosure is to provide a communication apparatus, a method of a communication apparatus, a terminal apparatus, a method of a terminal apparatus, a communication system, and a non-transitory computer-readable medium capable of preventing a rapid increase in traffic in a mobile communication network capable of providing a communication service when a disaster occurs.

### Solution to Problem

A communication apparatus according to a first aspect includes: a transmission unit configured to transmit list information indicating networks that are available when a disaster occurs in a case where identification information of a terminal apparatus is associated with a high-priority terminal, and configured not to transmit the list information in a case where the identification information is not associated with the high-priority terminal.

A method of a communication apparatus according to a second aspect includes: transmitting list information indicating networks that are available when a disaster occurs in a case where identification information of a terminal apparatus is associated with a high-priority terminal, and not transmitting the list information in a case where the identification information is not associated with the high-priority terminal.

A terminal apparatus according to a third aspect includes: a reception unit configured to receive list information indicating networks available when a disaster occurs in a case where identification information of the own apparatus is associated with a high-priority terminal; and a transmission unit configured to transmit a registration request message to the network indicated in the list information when a disaster occurs.

A method of a terminal apparatus according to a fourth aspect includes: receiving list information indicating networks available when a disaster occurs in a case where identification information of an own apparatus is associated with a high-priority terminal; and transmitting a registration request message to the network indicated in the list information when a disaster occurs.

A communication system according to a fifth aspect includes: a communication apparatus configured to transmit, in a case where identification information of a terminal apparatus is associated with a high-priority terminal, list information indicating networks available when a disaster occurs, and configured not to transmit the list information in a case where the identification information is not associated with the high-priority terminal; and a terminal apparatus configured to receive, in a case where identification information of the own apparatus is associated with the high-priority terminal, the list information indicating the networks available when a disaster occurs, and transmit a registration request message to the network indicated in the list information when a disaster occurs.

A program according to a sixth aspect executes: transmitting list information indicating networks that are available when a disaster occurs in a case where identification information of a terminal apparatus is associated with a high-priority terminal, and not transmitting the list information in a case where the identification information is not associated with the high-priority terminal.

### Advantageous Effects of Invention

According to the present disclosure, it is possible to provide a communication apparatus, a method of a communication apparatus, a terminal apparatus, a method of a terminal apparatus, a communication system, and a non-transitory computer-readable medium capable of preventing a rapid increase in traffic in a mobile communication network capable of providing a communication service when a disaster occurs.

### BRIEF DESCRIPTION OF DRAWINGS

FIG. 1A is a configuration diagram of a communication apparatus according to a first example embodiment.

FIG. 1B is a configuration diagram of a terminal apparatus according to the first example embodiment.

FIG. 2 is a configuration diagram of a communication apparatus according to a second example embodiment.

FIG. 3 is a flowchart of communication processing according to the second example embodiment.

FIG. 4 is a configuration diagram of a communication system according to a third example embodiment.

FIG. 5 is a diagram illustrating a flow of Registration processing according to the third example embodiment.

FIG. 6 is a diagram illustrating a flow of Registration processing according to a modified example of the third example embodiment.

FIG. 7 is a diagram illustrating a flow of Registration processing according to the modified example of the third example embodiment.

FIG. 8 is a diagram illustrating a flow of Registration processing according to the modified example of the third example embodiment.

FIG. 9 is a configuration diagram of the communication apparatus and the terminal apparatus according to each example embodiment.

### EXAMPLE EMBODIMENT

### First Example Embodiment

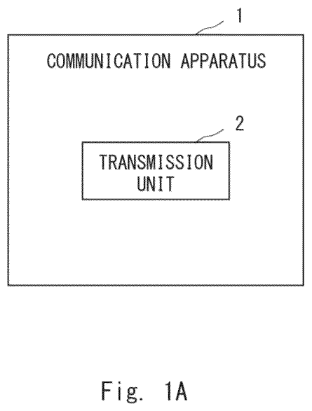

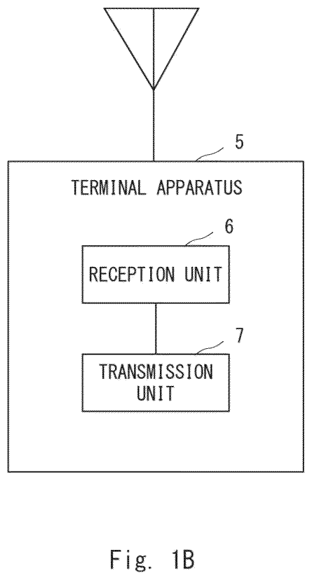

An example embodiment of the present disclosure will be described below with reference to the drawings. FIG. 1A is a configuration example of a communication apparatus 1 according to a first example embodiment. The communication apparatus 1 may be a computer apparatus that operates when a processor executes a program stored in a memory. The communication apparatus 1 includes a transmission unit 2. The transmission unit 2 may be a software component or module whose processing is carried out by causing the processor to execute the program stored in the memory. Alternatively, the transmission unit 2 may be a hardware component such as a circuit or a chip.

In a case where identification information of a terminal apparatus is associated with a high-priority terminal, the transmission unit 2 transmits list information indicating networks that are available when a disaster occurs, and in a case where the identification information is not associated with the high-priority terminal, the transmission unit 2 does not transmit the list information.

The identification information of the terminal apparatus may be information for uniquely identifying the terminal apparatus. Alternatively, the identification information of the terminal apparatus may be information for uniquely identifying a user who uses the terminal apparatus. The high-priority terminal may be, for example, a terminal apparatus that requires preferential use for emergency, medical treatment, firefighting, police, and maintenance and management of lifelines (electricity, water, gas, and public Institutions).

The terminal apparatus accesses a network provided by a communication carrier and uses a communication service. However, when a failure occurs in the network provided by the communication carrier due to the occurrence of a disaster, the terminal apparatus cannot access the network provided by the communication carrier and cannot use the communication service. In such a case, the terminal apparatus can continuously use the communication service by accessing another network instead of the failed network. That is, a network available to the terminal apparatus when a disaster occurs is a network that can provide the communication service to the terminal apparatus on behalf of the failed network. In addition, the network available to the terminal apparatus when a disaster occurs may be a network provided by a communication carrier different from the communication carrier providing the network that the terminal apparatus used before the disaster occurred.

The list information includes identification information of at least one network different from a network to which the communication apparatus 10 belongs.

Next, a configuration example of a terminal apparatus 5 according to the first example embodiment will be described with reference to FIG. 1B. The terminal apparatus 5 may be a computer apparatus that operates when a processor executes a program stored in a memory. The terminal apparatus 5 includes a reception unit 6 and a transmission unit 7. The reception unit 6 and the transmission unit 7 may be software components or modules whose processing is carried out by causing the processor to execute the program stored in the memory. Alternatively, the reception unit 6 and the transmission unit 7 may be hardware components such as circuits or chips.

When the identification information of the terminal apparatus 5 is associated with the high-priority terminal, the reception unit 6 receives the list information indicating the networks available when a disaster occurs. For example, the reception unit 6 receives the list information from the communication apparatus 1.

The transmission unit 7 transmits a registration request message to a network indicated in the list information when a disaster occurs.

As described above, the communication apparatus 1 according to the first example embodiment transmits the list information to the terminal apparatus associated with the high-priority terminal. On the other hand, the communication apparatus 1 according to the first example embodiment does not transmit the list information to a terminal apparatus that is not associated with the high-priority terminal. As a result, when a disaster occurs, only the terminal apparatus having the list information transmits the registration request message to the network. It is possible to prevent a terminal apparatus that does not correspond to the high-priority terminal from accessing the network available when a disaster occurs. Thereby, the number of terminal apparatuses that can access the network available when a disaster occurs can be limited. As only the high-priority terminal transmits the registration request message, a possibility that congestion (traffic concentration) occurs can be suppressed as compared with a case where the list information is transmitted to all the terminal apparatuses, and all the terminal apparatuses having the list information transmit the registration request message when a disaster occurs.

### Second Example Embodiment

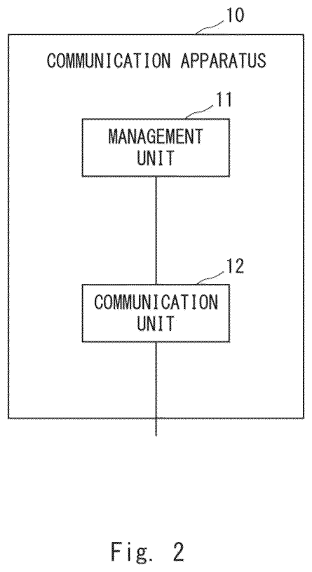

An example embodiment of the present disclosure will be described below with reference to the drawings. FIG. 2 is a configuration example of a communication apparatus 10 according to a second example embodiment. The communication apparatus 10 corresponds to the communication apparatus 1 in the first example embodiment. The communication apparatus 10 may be a computer apparatus that operates when a processor executes a program stored in a memory. The communication apparatus 10 may be a node apparatus included in a mobile communication network.

The communication apparatus 10 includes a management unit 11 and a communication unit 12. The communication unit 12 may include a transmission unit and a reception unit. The management unit 11 and the communication unit 12 may be software components or modules whose processing is carried out by causing the processor to execute the program stored in the memory. Alternatively, the management unit 11 and the communication unit 12 may be hardware components such as circuits or chips.

The management unit 11 manages list information indicating networks available to a terminal apparatus when a disaster occurs. Alternatively, the management unit 11 may store the list information as a storage unit. The terminal apparatus may be a computer apparatus having a communication function, such as a mobile terminal, a wireless terminal, a smartphone terminal, a tablet terminal, an Internet of Things (IoT) terminal, a machine type communication (MTC) terminal, or a user terminal.

The list information managed by the management unit 11 includes identification information of at least one network different from a network to which the communication apparatus 10 belongs. The management unit 11 may receive the list information from another communication apparatus that manages the list information via a network. Alternatively, the management unit 11 may manage the list information input to the communication apparatus 10 by an administrator or the like of the communication apparatus 10.

The communication unit 12 receives identification information of the terminal apparatus. In a case where the identification information is associated with a high-priority terminal, the communication unit 12 transmits the list information to the terminal apparatus. In a case where the identification information is not associated with the high-priority terminal, the communication unit 12 does not transmit the list information to the terminal apparatus.

The identification information of the terminal apparatus may be information for uniquely identifying the terminal apparatus. Alternatively, the identification information of the terminal apparatus may be information for uniquely identifying a user who uses the terminal apparatus. The high-priority terminal may be a terminal apparatus that can access an accessible network at the time of disaster. In other words, the high-priority terminal may be a terminal apparatus that can access a network included in the list information at the time of disaster. The identification information of the terminal apparatus corresponding to the high-priority terminal may be managed in a database or the like that manages the identification information of the terminal apparatus corresponding to the high-priority terminal. For example, only the identification information of the terminal apparatus corresponding to the high-priority terminal may be managed in the database, and the identification information of the terminal apparatus corresponding to the high-priority terminal and the identification information of the terminal apparatus that does not corresponds to the high-priority terminal may be managed separately.

The communication apparatus 10 may manage the database, or another communication apparatus or the like may manage the database. In a case where the communication apparatus 10 manages the database, the management unit 11 may manage the database. In a case where another communication apparatus different from the communication apparatus 10 manages the database, the communication apparatus 10 may inquire of the another communication apparatus whether or not the identification information received from the terminal apparatus is associated with the high-priority terminal.

Not transmitting the list information to the terminal apparatus may mean that the communication unit 12 transmits a message indicating that the list information is not configured to the terminal apparatus.

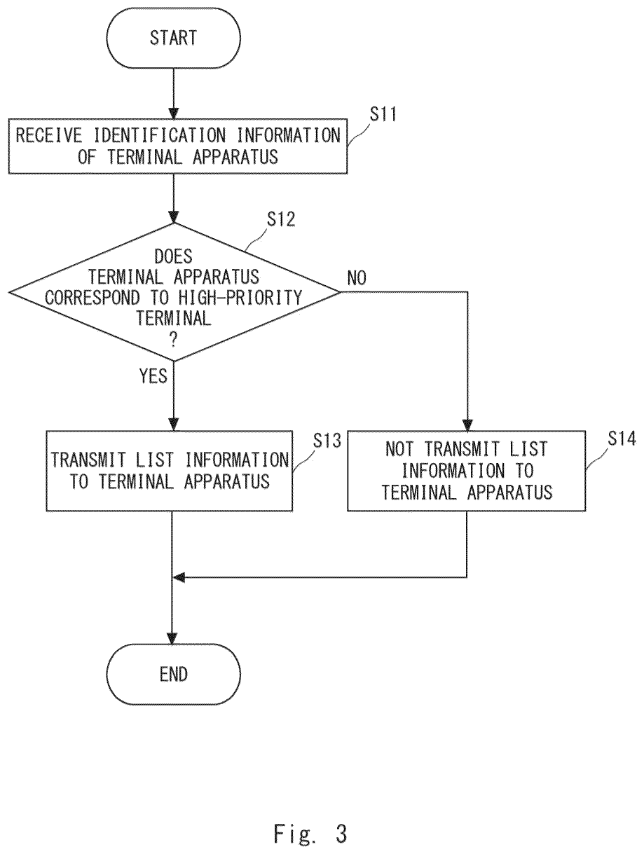

Next, a flowchart of communication processing according to the second example embodiment will be described with reference to FIG. 3. First, the communication unit 12 receives the identification information of the terminal apparatus (S11). Next, in a case where the identification information of the terminal apparatus is associated with the high-priority terminal (S12), the communication unit 12 acquires the list information from the management unit 11 and transmits the list information to the terminal apparatus (S13). The list information includes information indicating at least one network available to the terminal apparatus when a disaster occurs. In a case where the identification information of the terminal apparatus is not associated with the high-priority terminal (S12), the communication unit 12 does not transmit the list information to the terminal apparatus (S14).

As described above, the communication apparatus transmits the list information to the terminal apparatus corresponding to the high-priority terminal, and does not transmit the list information to the terminal apparatus that does not correspond to the high-priority terminal. As a result, when a disaster occurs, it is possible to prevent the terminal apparatus that does not correspond to the high-priority terminal from accessing a network different from the network that the terminal apparatus accessed before the disaster occurred. By limiting the number of terminal apparatuses that can access a network that provides a communication service on behalf of a network in which a failure has occurred due to a disaster, it is possible to prevent a rapid increase in traffic in the network that provides the communication service.

### Third Example Embodiment

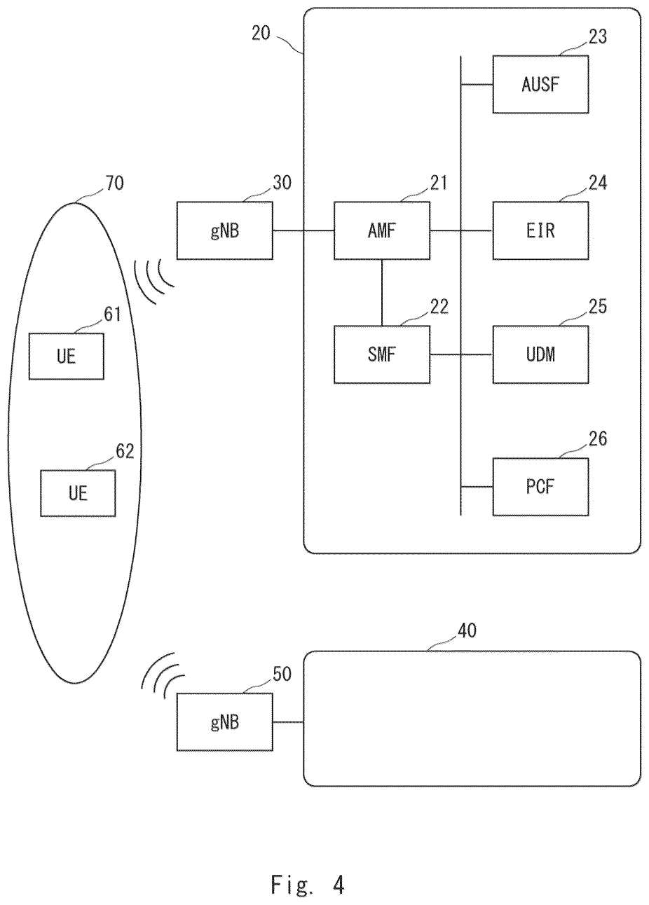

Next, a configuration example of a communication system according to a third example embodiment will be described with reference to FIG. 4. The communication system in FIG. 4 includes a 5th generation core network (5GC) 20, a gNodeB (gNB) 30, a 5GC 40, and a gNB 50.

The gNB 30 and the gNB 50 correspond to base stations supporting 5G which is a wireless communication standard defined in 3rd Generation Partnership Project (3GPP). The gNB 30 forms a communication area 70. Furthermore, FIG. 4 illustrates that the gNB 50 forms the communication area 70 similarly to the gNB 30, but the communication area formed by the gNB 50 may be an area overlapping a part of the communication area 70. Alternatively, the communication area formed by the gNB 50 may be an area including the communication area 70. A UE 61 and a UE 62 are present in the communication area 70.

The UE 61 and the UE 62 each correspond to the terminal apparatus in the first example embodiment. The UE is used as a generic name of the terminal apparatus in 3GPP. In the third and subsequent example embodiments, the UE 61 will be described as a high-priority terminal, and the UE 62 will be described as a general terminal different from the high-priority terminal.

Here, it is assumed that the communication system in FIG. 4 includes a communication system managed by two communication carriers. For example, a communication carrier A may manage the 5GC 20 and the gNB 30, and a communication carrier B may manage the 5GC 40 and the gNB 50. Since a configuration of the 5GC 40 is substantially the same as a configuration of the 5GC 20, a detailed description thereof will be omitted. However, the 5GC 20 may have a redundant configuration different from that of the 5GC 40, and for example, the number of node apparatuses included in the 5GC 40 may be different from the number of node apparatuses included in the 5GC 20.

Furthermore, in the communication system of FIG. 4, an example in which the gNB 30 and the gNB 50 are different apparatuses is illustrated, but the gNB 30 and the gNB 50 may be the same apparatus. In other words, the 5GC 20 and the 5GC 40 may share one gNB.

The 5GC 20 includes an access and mobility management function (AMF) entity 21, a session management function (SMF) entity 22, an authentication server function (AUSF) entity 23, an equipment identity register (EIR) 24, a unified data management (UDM) entity 25, and a policy control function (PCF) entity 26. The AMF entity 21 is referred to as an AMF 21 in the following description. The SMF entity 22 is referred to as an SMF 22 in the following description. The AUSF entity 23 is referred to as an AUSF 23 in the following description. The UDM entity 25 is referred to as a UDM 25 in the following description. The PCF entity 26 is referred to as a PCF 26 in the following description. The AMF, the SMF, the AUSF, the EIR, and the UDM are apparatuses included in a core network. The EIR, the UDM, or the AUSF is also referred to as a storage device, a server, or a management apparatus. The storage device, the server, or the management apparatus may be a computer apparatus having a communication function. The entity may be referred to as a node or an apparatus.

The AMF 21 performs mobility management of the UE 61 and the UE 62. Furthermore, the AMF 21 executes authentication processing for the UE 61 and the UE 62. The authentication processing for the UE may be, for example, authentication processing related to a subscriber identity module (SIM) mounted on the UE. The SMF 22 executes session management related to the UE 61 and the UE 62. The AUSF 23 executes authentication processing related to the UE 61 and the UE 62 together with the AMF 21.

The EIR 24 manages terminal numbers related to the UE 61 and the UE 62. The terminal number may be, for example, a permanent equipment identifier (PEI). The UDM 25 manages authentication certificate information used for the authentication processing for the UE 61 and the UE 62. Further, the UDM 25 manages subscriber information or user information related to the UE 61 and the UE 62. The PCF 26 performs policy control in a communication system provided by the communication carrier A.

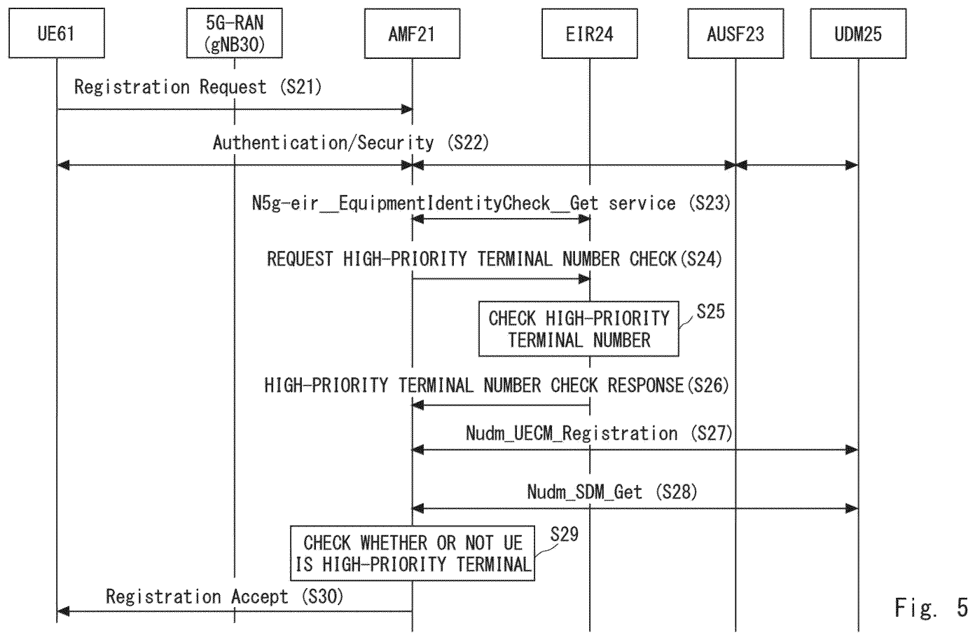

Next, a flow of Registration processing according to the third example embodiment will be described with reference to FIG. 5. In the Registration processing illustrated in FIG. 5, portions necessary for description of the present disclosure are extracted from a Registration procedure disclosed in FIG. 4.2.2.2.2-1 of 3GPP TS 23.502 V17.3.0, and processing related to the present disclosure is further added.

First, the UE 61 transmits a Registration Request message to the AMF 21 via a 5G-radio access network (5G-RAN) (S21). The 5G-RAN is an access network supporting the 5G wireless communication standard, and specifically includes a communication apparatus or the like not specified in the gNB 30 or 3GPP. In the following description of FIG. 5, a gNB will be used as a specific apparatus included in the 5G-RAN. The Registration Request message includes the PEI, a public land mobile network (PLMN) ID, and a parameter used for authentication. The PEI corresponds to identification information of the terminal apparatus. The PLMN ID is an ID for identifying a communication network system. For example, the PLMN ID included in the Registration Request message may be an ID indicating a communication network system provided by the communication carrier A.

Next, the UE 61, the AMF 21, the AUSF 23, and the UDM 25 execute the authentication processing related to the UE 61 (S22). When the AMF 21, the AUSF 23, and the UDM 25 authenticate the UE 61, the AUSF 23 transmits security related information to the AMF 21.

Next, the AMF 21 executes N5g-eir_EquipmentIdentityCheck_Get service processing, which is authentication processing related to the terminal apparatus used as the UE 61, together with the EIR 24 (S23). The authentication processing related to the terminal apparatus may be, for example, checking the PEI of the UE 61. The EIR 24 may manage PEIs indicating unauthorized terminals. Further, the EIR 24 may check whether or not the PEI of the UE 61 received from the AMF 21 is included in the PEIs indicating the unauthorized terminals. Alternatively, in a case where the EIR 24 manages PEIs that do not correspond to the unauthorized terminals, the EIR 24 may check whether or not the PEI of the UE 61 received from the AMF 21 is included in the PEIs that do not correspond to the unauthorized terminals. Here, it is assumed that the EIR 24 transmits, to the AMF 21, a check result indicating that the terminal apparatus used as the UE 61 does not correspond to the unauthorized terminal.

The unauthorized terminal may be, for example, a terminal apparatus that is not permitted to use a network managed by the communication carrier A. Next, the AMF 21 transmits a message requesting a high-priority terminal number check to the EIR 24 (S24). The AMF 21 transmits a message including the PEI of the UE 61 to the EIR 24.

Next, the EIR 24 checks whether or not the PEI of the UE 61 corresponds to the high-priority terminal (S25). The EIR 24 manages PEIs of the high-priority terminals. The EIR 24 may manage a list of the PEIs of the high-priority terminals in a database, or may manage information in which the PEIs of the high-priority terminals and PEIs that do not correspond to the high-priority terminals are distinguished from each other in the database. For example, the EIR 24 may check whether or not the PEI of the UE 61 is included in the managed PEIs of the high-priority terminals. In other words, the EIR 24 may check whether or not the PEI of the UE 61 matches the managed PEIs of the high-priority terminals.

Next, the EIR 24 transmits a response message including the check result to the AMF 21 (S26). In step S26, the EIR 24 transmits a response message including the check result indicating that the UE 61 is the high-priority terminal to the AMF 21. In a case where the UE 61 is not the high-priority terminal, the EIR 24 may transmit a response message including the check result indicating that the UE is not the high-priority terminal to the AMF 21.

Next, the AMF 21 registers with the UDM 25 by using Nudm_UECM_Registration (S27). Specifically, the AMF 21 notifies the UDM 25 that the UE 61 is present in the communication area of the gNB 30 managed by the AMF 21 by using a message used in Nudm_UECM_Registration. In other words, the AMF 21 notifies the UDM 25 of information to be registered of the AMF 21 used by the UE 61.

Next, the AMF 21 acquires subscriber data related to the UE 61 from the UDM 25 by using Nudm_SDM_Get (S28). In the AMF 21, a management unit manages list information indicating networks available to the UE 61 when a disaster occurs. In addition, the AMF 21 may store the list information in a storage unit. The list information managed by the AMF 21 may be included in subscriber data (subscriber information) acquired from the UDM. The list information includes at least one PLMN.

Next, the AMF 21 checks whether or not the check result received in step S26 indicates that the UE 61 is the high-priority terminal (S29). Here, it is assumed that the UE 61 is the high-priority terminal, and thus, the AMF 21 transmits a Registration Accept message including the list information to the UE 61 via the gNB 30 (S30). As a result, the Registration processing of the UE 61 to the AMF 21 is completed, and the UE 61 holds the list information. In addition, in a case where it is determined in step S29 that the UE that has transmitted the Registration Request message is not the high-priority terminal, the AMF 21 transmits the Registration Accept message not including the list information to the UE (S30).

When a disaster occurs after the Registration processing is completed and communication via the gNB 30 and the 5GC 20 cannot be performed, the UE 61 transmits the Registration Request message in which the PLMN included in the list information is configured to a gNB different from the gNB 30. For example, the UE 61 may transmit, to the gNB 50, the Registration Request message in which a parameter indicating that a Registration type is Disaster Roaming Registration and the PLMN available at the time of disaster are configured. In addition, the UE 61 may transmit the Registration Request message including information such as an indication or flag indicating that the identification information of the own apparatus is associated with the high-priority terminal. The 5GC 40 that has received the Registration Request message via the gNB 50 may include a mechanism for determining whether to perform Registration of the UE 61 by using the information configured in the Registration Request message. At that time, a communication apparatus (for example, the EIR, the UDM, the AMF, or the AUSF) in the 5GC 40 may check whether or not the UE 61 is associated with the high-priority terminal based on the information such as the indication or flag transmitted from the UE 61 and determine whether or not to perform the Registration. When the Registration processing in the 5GC 40 is completed, the UE 61 can perform communication via the gNB 30 and the 5GC 20 instead of the gNB 50 and the 5GC 40. In other words, the UE 61 can receive the provision of the communication service by the gNB 50 and the 5GC 40.

As described above, the EIR 24 according to the third example embodiment uses the terminal number of the UE 61 that has transmitted the Registration Request message to check whether or not the terminal apparatus used as the UE 61 is the high-priority terminal. Further, in a case where the UE 61 is the high-priority terminal, the AMF 21 transmits the list information indicating the networks available to the terminal apparatus when a disaster occurs to the UE 61, and does not transmit the list information to the UE that is not the high-priority terminal. As a result, it is possible to further limit the UEs holding the list information as compared with a case where the list information is transmitted to all the UEs for which the AMF 21 permits Registration. As a result, when a disaster occurs, it is possible to reduce the number of UEs for which Registration is performed with respect to the PLMN included in the list information, and thus, it is possible to prevent congestion (traffic concentration) from occurring in the PLMN included in the list information.

In addition, the UDM 25 may associate the list information including information indicating different networks for each UE. In this case, the UDM 25 transmits the list information associated with the UE 61 in step S28. In the Registration processing of the high-priority terminal different from the UE 61, the UDM 25 transmits list information different from the list information transmitted to the UE 61. The different list information refers to list information in which networks included in the list information are different. As a result, when a disaster occurs, Registration to different networks is performed for each UE corresponding to the high-priority terminal. As a result, it is possible to reduce a possibility that congestion occurs in the PLMN included in the list information as compared with a case where the same list information is transmitted to a plurality of high-priority terminals.

### Modified Example of Third Example Embodiment

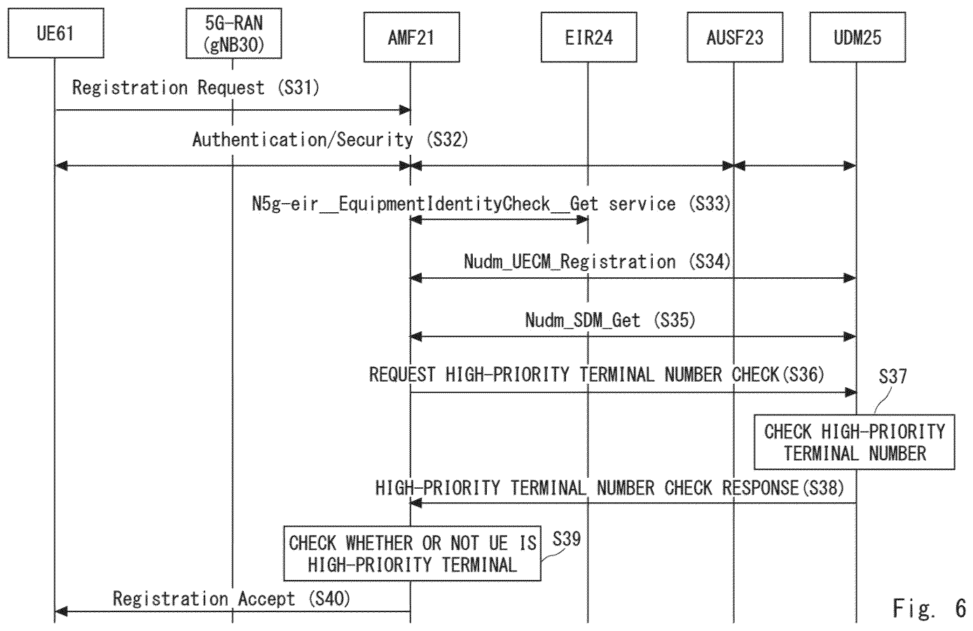

Next, a modified example of the Registration processing in FIG. 5 will be described with reference to FIG. 6. In FIG. 5, an example in which the EIR 24 checks whether or not the UE 61 corresponds to the high-priority terminal has been described, and in FIG. 6, a flow of processing in which the UDM 25 checks whether or not the UE 61 corresponds to the high-priority terminal will be described. Steps S31 to S35 in FIG. 6 are similar to steps S21 to S23, S27, and S28 in FIG. 5, and thus a detailed description thereof is omitted.

After the AMF 21 acquires the subscriber data related to the UE 61 from the UDM 25 in step S35, the AMF 21 transmits a message requesting a priority terminal number check to the UDM 25 (S36). The AMF 21 transmits a message including the terminal number of the UE 61 to the UDM 25. The terminal number may be the PEI.

Next, the UDM 25 checks whether or not the terminal number of the UE 61 corresponds to the high-priority terminal (S37). The UDM 25 manages terminal numbers of the high-priority terminals. The UDM 25 may manage the terminal numbers corresponding to the high-priority terminals by using a database similarly to the EIR 24 in FIG. 5. The UDM 25 checks whether or not the terminal number of the UE 61 is included in the terminal numbers of the high-priority terminals.

Next, the UDM 25 transmits a response message including the check result to the AMF 21 (S38). In step S38, the UDM 25 transmits a response message including the check result indicating that the UE 61 is the high-priority terminal to the AMF 21.

Since steps S39 and S40 are similar to steps S29 and S30 in FIG. 5, a detailed description thereof is omitted.

As illustrated in FIG. 6, the UDM 25 checks whether or not the UE 61 corresponds to the high-priority terminal and transmits the check result to the AMF 21, so that the AMF 21 can transmit the list information only to the high-priority terminal similarly to the processing in FIG. 5.

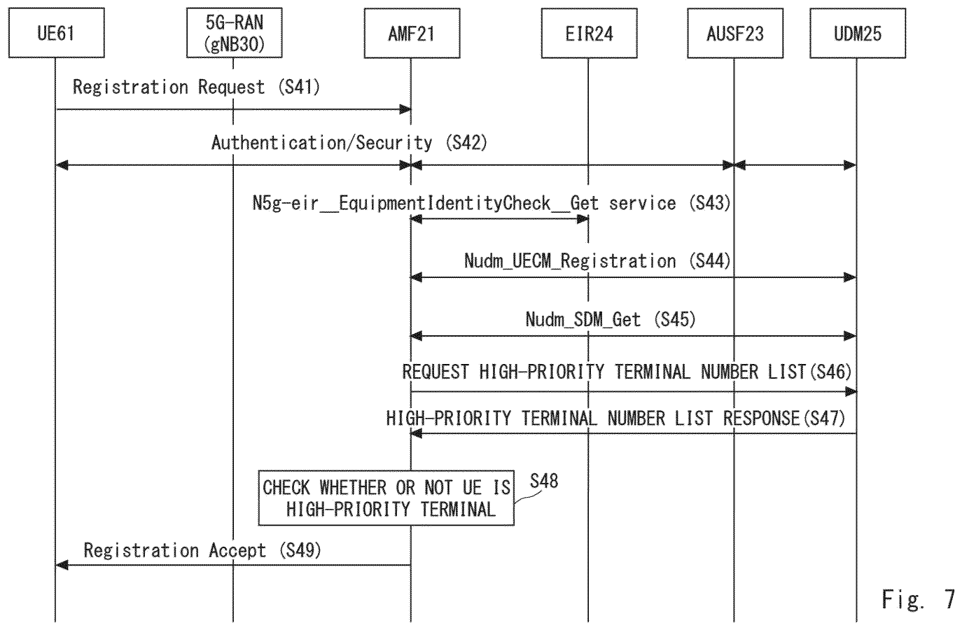

Next, a modified example of the Registration processing in FIGS. 5 and 6 will be described with reference to FIG. 7. In FIG. 5, an example in which the EIR 24 checks whether or not the UE 61 corresponds to the high-priority terminal has been described. Furthermore, in FIG. 6, an example in which the UDM 25 checks whether or not the UE 61 corresponds to the high-priority terminal has been described. In FIG. 7, an example in which the AMF 21 checks whether or not the UE 61 corresponds to the high-priority terminal will be described.

Steps S41 to S45 in FIG. 7 are similar to steps S21 to S23, S27, and S28 in FIG. 5, and thus a detailed description thereof is omitted.

After the AMF 21 acquires the subscriber data related to the UE 61 from the UDM 25 in step S45, the AMF 21 transmits a message requesting a high-priority terminal number list to the UDM 25 (S46). The high-priority terminal number list is information including the terminal numbers of the high-priority terminals, and includes, for example, at least one terminal number managed as the high-priority terminal.

Next, the UDM 25 transmits a response message including the high-priority terminal number list to the AMF 21 in response to the message received in step S46 (S47). Next, the AMF 21 checks whether or not the terminal number of the UE 61 corresponds to the high-priority terminal by using the high-priority terminal number list (S48). Here, it is assumed that the UE 61 is the high-priority terminal, and thus, the AMF 21 transmits a Registration Accept message including the list information to the UE 61 (S49). The list information included in the Registration Accept message from the AMF 21 is the list information indicating the networks available to the terminal apparatus when a disaster occurs, the list information being received from the UDM 25 in step S45. As a result, the Registration processing of the UE 61 to the AMF 21 is completed, and the UE 61 holds the list information. In addition, in a case where it is determined in step S48 that the UE that has transmitted the Registration Request message is not the high-priority terminal, the AMF 21 transmits the Registration Accept message not including the list information to the UE (S49).

As illustrated in FIG. 7, the AMF 21 acquires the high-priority terminal number list from the UDM 25, and checks whether or not the UE 61 corresponds to the high-priority terminal. As a result, the AMF 21 can transmit the list information only to the high-priority terminal, similarly to the processing in FIGS. 5 and 6.

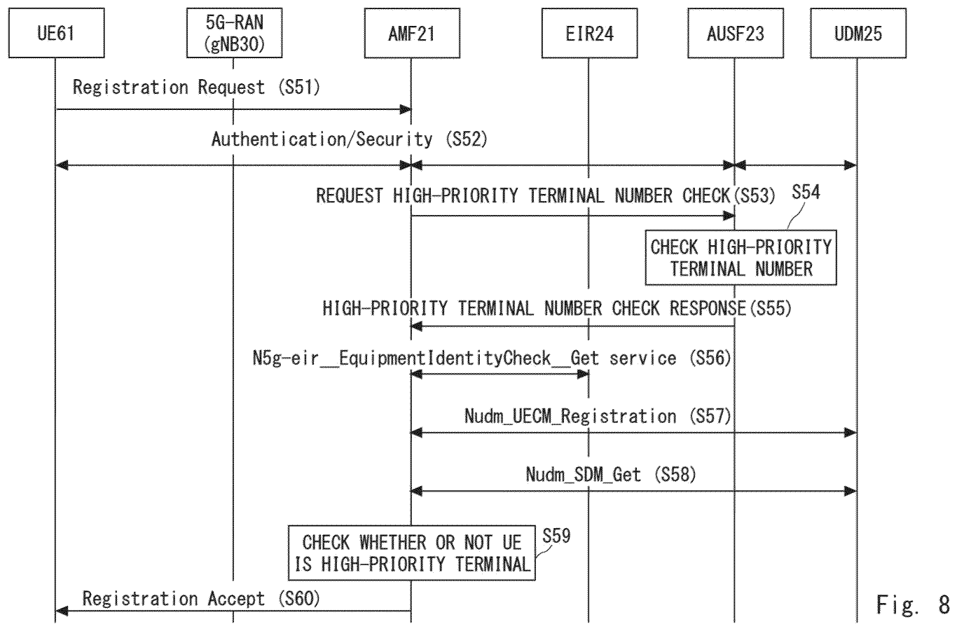

Next, a modified example of the Registration processing in FIGS. 5 to 7 will be described with reference to FIG. 8. In FIG. 5, an example in which the EIR 24 checks whether or not the UE 61 corresponds to the high-priority terminal has been described. Furthermore, in FIG. 6, an example in which the UDM 25 checks whether or not the UE 61 corresponds to the high-priority terminal has been described. Furthermore, in FIG. 7, an example in which the AMF 21 checks whether or not the UE 61 corresponds to the high-priority terminal has been described. In FIG. 8, an example in which the AUSF 23 checks whether or not the UE 61 corresponds to the high-priority terminal will be described.

Since steps S51 and S52 are similar to steps S21 and S22 in FIG. 5, a detailed description thereof is omitted. When the AMF 21, the AUSF 23, and the UDM 25 complete the authentication processing related to the UE 61, the AMF 21 transmits a message requesting the high-priority terminal number check to the AUSF 23 (S53). The AMF 21 transmits a message including the terminal number of the UE 61 to the AUSF 23.

Next, the AUSF 23 checks whether or not the terminal number of the UE 61 corresponds to the high-priority terminal (S54). The AUSF 23 manages the terminal numbers of the high-priority terminals. The AUSF 23 may manage the terminal numbers corresponding to the high-priority terminals by using a database similarly to the EIR 24 in FIG. 5. For example, the AUSF 23 checks whether or not the terminal number of the UE 61 is included in the terminal numbers of the high-priority terminals.

Next, the AUSF 23 transmits a response message including the check result to the AMF 21 (S55). In step S55, the UDM 25 transmits a response message including the check result indicating that the UE 61 is the high-priority terminal to the AMF 21.

Step S56 to S60 is similar to steps S23 and S27 to 30 in FIG. 5, and thus a detailed description thereof will be omitted.

As illustrated in FIG. 8, the AUSF 23 checks whether or not the UE 61 corresponds to the high-priority terminal and transmits the check result to the AMF 21, so that the AMF 21 can transmit the list information only to the high-priority terminal similarly to the processing in FIG. 5.

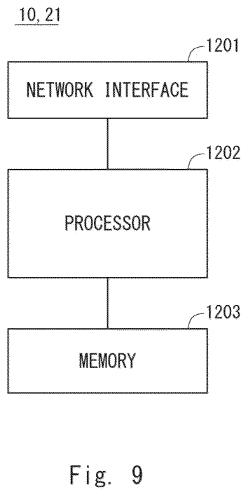

FIG. 9 is a block diagram illustrating a configuration example of the communication apparatus 10 and the AMF 21 (hereinafter, referred to as the communication apparatus 10 and the like), and the terminal apparatus described in the above-described example embodiments. Referring to FIG. 9, the communication apparatus 10 and the like and the terminal apparatus include a network interface 1201, a processor 1202, and a memory 1203. The network interface 1201 may be used to communicate with network nodes. The network interface 1201 may include, for example, a network interface card (NIC) conforming to IEEE 802.3 series. IEEE represents Institute of Electrical and Electronics Engineers.

The processor 1202 executes the processing in the communication apparatus 10 and the like described using the flowcharts in the above-described example embodiments, by reading software (computer programs) from the memory 1203 and executing the software. The processor 1202 may be, for example, a microprocessor, a micro processing unit (MPU), or a central processing unit (CPU). The processor 1202 may include a plurality of processors.

The memory 1203 is configured in a combination of a volatile memory and a nonvolatile memory. The memory 1203 may include a storage disposed away from the processor 1202. In this case, the processor 1202 may access the memory 1203 through an input/output (I/O) interface (not shown).

In the example of FIG. 9, the memory 1203 is used to store a group of software modules. The processor 1202 can execute the processing in the communication apparatus 10 and the like described in the above-described example embodiments by reading the group of software modules from the memory 1203 and executing the group of software modules.

As described with reference to FIG. 9, each of the processors included in the communication apparatus 10 and the like in the above-described example embodiments executes one or a plurality of programs including a command group for causing a computer to perform the algorithm described with reference to the drawings.

In the above-described example, the program includes a group of instructions (or software code) for causing a computer to perform one or more functions described in the example embodiments when being read by the computer. The program may be stored in a non-transitory computer-readable medium or a tangible storage medium. As an example and not by way of limitation, the computer-readable medium or the tangible storage medium includes a random-access memory (RAM), a read-only memory (ROM), a flash memory, a solid-state drive (SSD) or any other memory technology, a CD-ROM, a digital versatile disc (DVD), a Blu-ray (registered trademark) disc or any other optical disc storage, a magnetic cassette, a magnetic tape, a magnetic disk storage, and any other magnetic storage devices. The program may be transmitted on a transitory computer-readable medium or a communication medium. As an example and not by way of limitation, the transitory computer readable medium or the communication medium includes electrical, optical, acoustic, signals, or propagated signals in other forms.

Note that the present disclosure is not limited to the above-described example embodiments, and can be appropriately modified without departing from the scope. The above-described example embodiments may be used in combination.

Some or all of the above-described example embodiments may be described as in the following Supplementary Notes, but are not limited to the following Supplementary Notes.

### (Supplementary Note 1)

A communication apparatus including a transmission unit configured to transmit list information indicating networks that are available when a disaster occurs in a case where identification information of a terminal apparatus is associated with a high-priority terminal, and configured not to transmit the list information in a case where the identification information is not associated with the high-priority terminal.

### (Supplementary Note 2)

The communication apparatus according to Supplementary Note 1, in which the transmission unit transmits the list information to the terminal apparatus via a base station.

### (Supplementary Note 3)

The communication apparatus according to Supplementary Note 1 or 2, further including a reception unit configured to receive the identification information from another apparatus.

### (Supplementary Note 4)

The communication apparatus according to any one of Supplementary Notes 1 to 3, further including a management unit configured to manage the list information.

### (Supplementary Note 5)

The communication apparatus according to any one of Supplementary Notes 1 to 4, further including a management unit configured to manage the list information.

### (Supplementary Note 6)

The communication apparatus according to any one of Supplementary Notes 1 to 5, in which the identification information is information for identifying the terminal apparatus or information for identifying a user who uses the terminal apparatus.

### (Supplementary Note 7)

The communication apparatus according to Supplementary Note 3, in which
the reception unit receives a registration request message including the identification information from the terminal apparatus, and
the transmission unit transmits, in a case where the identification information is associated with the high-priority terminal, a response message including the list information to the terminal apparatus in response to the registration request message, and transmits, in a case where the identification information is not associated with the high-priority terminal, the response message that does not include the list information to the terminal apparatus.

### (Supplementary Note 8)

The communication apparatus according to any one of Supplementary Notes 1 to 7, in which the list information includes at least one public land mobile network (PLMN).

### (Supplementary Note 9)

The communication apparatus according to Supplementary Note 3, in which
the transmission unit transmits the identification information of the terminal apparatus to a management apparatus that manages identification information of the high-priority terminal, and
the reception unit receives, from the management apparatus, a determination result as to whether or not the identification information of the terminal apparatus is managed as the high-priority terminal.

### (Supplementary Note 10)

The communication apparatus according to Supplementary Note 3, in which
the reception unit receives information indicating a list of pieces of identification information of the high-priority terminals from a management apparatus that manages the list of pieces of identification information of the high-priority terminals, and
the communication apparatus further includes a determination unit configured to determine whether or not the identification information of the terminal apparatus is included in the list of pieces of identification information of the high-priority terminals.

### (Supplementary Note 11)

The communication apparatus according to Supplementary Note 9 or 10, in which the management apparatus is an equipment identity register (EIR), a unified data management (UDM) entity, or an authentication server function (AUSF) entity.

### (Supplementary Note 12)

The communication apparatus according to Supplementary Note 3, in which the reception unit receives a registration request message including the identification information from the terminal apparatus, and receives subscriber information of the terminal apparatus and the list information from a UDM entity that manages the subscriber information of the terminal apparatus.

### (Supplementary Note 13)

A method of a communication apparatus, the method including:
transmitting list information indicating networks that are available when a disaster occurs in a case where identification information of a terminal apparatus is associated with a high-priority terminal; and
not transmitting the list information in a case where the identification information is not associated with the high-priority terminal.

### (Supplementary Note 14)

The method according to Supplementary Note 13, in which the list information is transmitted to the terminal apparatus via a base station.

### (Supplementary Note 15)

The method according to Supplementary Note 13 or 14, in which the identification information is received from another apparatus.

### (Supplementary Note 16)

The method according to any one of Supplementary Notes 13 to 15, in which the identification information is information for identifying the terminal apparatus or information for identifying a user who uses the terminal apparatus.

### (Supplementary Note 17)

A terminal apparatus including:
a reception unit configured to receive list information indicating networks available when a disaster occurs in a case where identification information of the own apparatus is associated with a high-priority terminal; and
a transmission unit configured to transmit a registration request message to the network indicated in the list information when a disaster occurs.

### (Supplementary Note 18)

The terminal apparatus according to Supplementary Note 17, in which
the reception unit receives the list information from a first base station, and
the transmission unit transmits the registration request message to a second base station different from the first base station.

### (Supplementary Note 19)

The terminal apparatus according to Supplementary Note 17 or 18, in which the identification information is information for identifying the terminal apparatus or information for identifying a user who uses the terminal apparatus.

### (Supplementary Note 20)

A method of a terminal apparatus, the method including:
receiving list information indicating networks available when a disaster occurs in a case where identification information of an own apparatus is associated with a high-priority terminal; and
transmitting a registration request message to the network indicated in the list information when a disaster occurs.

### (Supplementary Note 21)

The method according to Supplementary Note 20, in which
the list information is received from a first base station, and
the registration request message is transmitted to a second base station different from the first base station.

### (Supplementary Note 22)

The method according to Supplementary Note 20 or 21, in which the identification information is information for identifying the terminal apparatus or information for identifying a user who uses the terminal apparatus.

### (Supplementary Note 23)

A communication system including:
a communication apparatus configured to transmit, in a case where identification information of a terminal apparatus is associated with a high-priority terminal, list information indicating networks available when a disaster occurs, and configured not to transmit the list information in a case where the identification information is not associated with the high-priority terminal; and
a terminal apparatus configured to receive, in a case where identification information of the own apparatus is associated with the high-priority terminal, the list information indicating the networks available when a disaster occurs, and transmit a registration request message to the network indicated in the list information when a disaster occurs.

### (Supplementary Note 24)

The communication system according to Supplementary Note 23, in which the communication apparatus transmits the list information to the terminal apparatus via a base station.

### (Supplementary Note 25)

A non-transitory computer-readable medium storing a program for causing a computer to execute:
transmitting list information indicating networks that are available when a disaster occurs in a case where identification information of a terminal apparatus is associated with a high-priority terminal; and
not transmitting the list information in a case where the identification information is not associated with the high-priority terminal.

### REFERENCE SIGNS LIST

1 COMMUNICATION APPARATUS
2 TRANSMISSION UNIT
5 TERMINAL APPARATUS
6 RECEPTION UNIT
7 TRANSMISSION UNIT
10 COMMUNICATION APPARATUS
11 MANAGEMENT UNIT
12 COMMUNICATION UNIT
20 5GC
21 AMF
22 SMF
23 AUSF
24 EIR
25 UDM
26 PCF
30 gNB
40 5GC
50 gNB
61 UE
62 UE
70 COMMUNICATION AREA

What is claimed is:

1. A communication apparatus comprising:
at least one memory storing instructions; and
at least one processor configured to execute the instructions to:
transmit list information indicating networks that are available when a disaster occurs in a case where identification information of a terminal apparatus is associated with a high-priority terminal, and configured not to transmit the list information in a case where the identification information is not associated with the high-priority terminal.

2. The communication apparatus according to claim 1, wherein the at least one processor is further configured to execute the instructions to transmit the list information to the terminal apparatus via a base station.

3. The communication apparatus according to claim 1, wherein the at least one processor is further configured to execute the instructions to receive the identification information from another apparatus.

4-5. (canceled)

6. The communication apparatus according to claim 1, wherein the identification information is information for identifying the terminal apparatus or information for identifying a user who uses the terminal apparatus.

7. The communication apparatus according to claim 3, wherein the at least one processor is further configured to execute the instructions to:
receive a registration request message including the identification information from the terminal apparatus; and
transmit, in a case where the identification information is associated with the high-priority terminal, a response message including the list information to the terminal apparatus in response to the registration request message, and transmits, in a case where the identification information is not associated with the high-priority terminal, the response message that does not include the list information to the terminal apparatus.

8. The communication apparatus according to claim 1, wherein the list information includes at least one public land mobile network (PLMN).

9. The communication apparatus according to claim 3, wherein the at least one processor is further configured to execute the instructions to:
transmit the identification information of the terminal apparatus to a management apparatus that manages identification information of the high-priority terminal; and
receive, from the management apparatus, a determination result as to whether or not the identification information of the terminal apparatus is managed as the high-priority terminal.

10. The communication apparatus according to claim 3, wherein the at least one processor is further configured to execute the instructions to:
receive information indicating a list of pieces of identification information of the high-priority terminals from a management apparatus that manages the list of pieces of identification information of the high-priority terminals; and
determine whether or not the identification information of the terminal apparatus is included in the list of pieces of identification information of the high-priority terminals.

11. (canceled)

12. The communication apparatus according to claim 3, wherein the at least one processor is further configured to execute the instructions to:
receive a registration request message including the identification information from the terminal apparatus; and
receive subscriber information of the terminal apparatus and the list information from a UDM entity that manages the subscriber information of the terminal apparatus.

13. A method of a communication apparatus, the method comprising:
transmitting list information indicating networks that are available when a disaster occurs in a case where identification information of a terminal apparatus is associated with a high-priority terminal; and
not transmitting the list information in a case where the identification information is not associated with the high-priority terminal.

14. The method according to claim 13, wherein the list information is transmitted to the terminal apparatus via a base station.

15. The method according to claim 13, wherein the identification information is received from another apparatus.

16. The method according to claim 13, wherein the identification information is information for identifying the terminal apparatus or information for identifying a user who uses the terminal apparatus.

17. A terminal apparatus comprising:
at least one memory storing instructions; and
at least one processor configured to execute the instructions to:
receive list information indicating networks available when a disaster occurs in a case where identification information of an own apparatus is associated with a high-priority terminal; and
transmit a registration request message to the network indicated in the list information when the disaster occurs.

18. The terminal apparatus according to claim 17, wherein the at least one processor is further configured to execute the instructions to:
receive the list information from a first base station; and
transmit the registration request message to a second base station different from the first base station.

19. The terminal apparatus according to claim 17, wherein the identification information is information for identifying the terminal apparatus or information for identifying a user who uses the terminal apparatus.

20. A method of a terminal apparatus, the method comprising:
receiving list information indicating networks available when a disaster occurs in a case where identification information of an own apparatus is associated with a high-priority terminal; and
transmitting a registration request message to the network indicated in the list information when the disaster occurs.

21. The method according to claim 20, wherein
the list information is received from a first base station, and
the registration request message is transmitted to a second base station different from the first base station.

22. The method according to claim 20, wherein the identification information is information for identifying the terminal apparatus or information for identifying a user who uses the terminal apparatus.

23-25. (canceled)
